(19) United States
(12) Patent Application Publication
(10) Pub. No.: US 2004/0174386 A1
(43) Pub. Date: Sep. 9, 2004

(54) Information processing method and image reproduction apparatus

(75) Inventors: Daisuke Kotake, Kanagawa (JP); Akihiro Katayama, Kanagawa (JP); Takaaki Endo, Chiba (JP); Masahiro Suzuki, Kanagawa (JP); Yukio Sakagawa, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/763,222

(22) Filed: Jan. 26, 2004

(30) Foreign Application Priority Data
Jan. 31, 2003 (JP) 2003-023823

(51) Int. Cl. G09G 5/00

(52) U.S. Cl. 345/633

(57) ABSTRACT

By simplifying determination of annotation display positions, annotations can be synthesized to a large number of images and the annotation-synthesized images can be then displayed with less work and time. To achieve this, a viewpoint position and a sight line direction on a map are determined, and the annotation display position of an object is determined from the position of the object on the map determined based on observation directions of the object in plural panoramic images, the viewpoint position, and the sight line direction. Then, an annotation image is synthesized to the annotation display position on an actually taken image corresponding to the viewpoint position.

### BACKGROUND OF THE INVENTION

1. Field of the Invention

The present invention relates to a method and an apparatus which set, in a virtual space which is constructed based on an actually taken image, a position of an annotation to be displayed on the actually taken image.

2. Related Background Art

An attempt at taking (or shooting) a real space by a camera mounted on a vehicle (or a movable body), and representing the taken real space as a virtual space based on taken real image data by using a computer has been proposed. For example, Endo, Katayama, Tamura, Hirose, Watanabe, Tanikawa: “Computer Visualization Of Cybercities Using Vehicle-Mounted Cameras”, Society Conference of IEICE (Institute of Electronics, Information and Communication Engineers), PA-3-4, pages 276-277, 1997, or Endo, Katayama, Tamura, Hirose, Watanabe, Tanikawa: Building Image-Based Cybercities By Using Vehicle-Mounted Cameras (2)-Generation Of Wide-Range Virtual Environment By Using Photo-Realistic Images-, Proc. of the Virtual Reality Society of Japan, Volume 2, pages 67-70 (1997.9) should be referred.

Incidentally, as a method of representing a taken real space as a virtual space based on data representing an actually taken image (hereinafter called actually taken image data), there is a method of reproducing a geometrical model of the real space from the actually taken image data and representing the reproduced model in conventional CG (Computer Graphics) technique. However, in this case, there are limits in accuracy of the model and truth to nature of the model. On one hand, IBR (Image-Based Rendering) technique of representing a virtual space by using the actually taken image without reproducing any geometrical model attracts attention in recent years. Here, because the IBR technique is based on the actually taken image, a realistic virtual space can be represented. Besides, although vast times and efforts are necessary to form the geometrical model which covers a vast space such as city and town, such time and effect are unnecessary in the IBR technique because any geometrical model is not reproduced.

To structure a virtual space which enables walk-through by using the IBR technique, it is necessary to generate and present an image according to the position of an experiencing person (also cited as an observer hereinafter) in the virtual space. For that purpose, in a system of this kind, each image frame of the actually taken image data is correlated with the position within the virtual space and stored in advance, the corresponding image frame is obtained based on the position and sight line direction of the experiencing person in the virtual space, and the obtained image frame is reproduced.

Incidentally, in order to enable the experiencing person to see a desired direction at each viewpoint position during the walk-through operation within the virtual space, the image frame corresponding to each viewpoint position is stored in advance as a panoramic image which covers the range wider than an angle of view at a time when the image at the viewpoint position in question is reproduced. That is, when the image in question is reproduced, the stored panoramic image is read based on the viewpoint position of the experiencing person within the virtual space, a partial image is cut out from the read panoramic image on the basis of the sight line direction of the observer, and the cut-out image is then displayed. When the trail of the viewpoint position within the virtual space is the same as the trail of the vehicle on which the camera is mounted, the observer feels as if the observer oneself takes the vehicle and runs.

Moreover, by synthesizing an annotation such as a name or the like of, e.g., a building to the building in question included in the image and displaying the synthesized annotation together with the image of the building in question, it is possible to provide more expressive information to the observer. Furthermore, by displaying such an annotation, a marker or a sign which is obscure because the actually taken image is dark can be clearly known and grasped by the observer.

When the virtual space is described and represented by using the geometrical model, the annotation can be synthesized and displayed at a desired position on the image. On one hand, when the virtual space is constructed in the IBR technique in which any geometrical model is not used, it is necessary to determine the display position of the annotation in regard to each image.

However, conventionally, when the annotation is synthesized and displayed in the above virtual space which has been constructed in the IBR technique, it is necessary for the user to manually determine the annotation display position in regard to each image, whereby it takes a lot of trouble with working in determining the annotation display position when there are a large number of images.

### SUMMARY OF THE INVENTION

The present invention has been made in consideration of such a conventional problem, and an object thereof is to simplify an operation for determining an annotation display position.

In order to achieve the above object, the present invention is characterized by an information processing method comprising: a viewpoint position/sight line direction determination step of determining a viewpoint position and a sight line direction on a map; an annotation display position determination step of determining an annotation display position of an object, from the position of the object in question on the map determined based on observation directions of the object in question in plural panoramic images, the viewpoint position, and the sight line direction; and a synthesis step of synthesizing an annotation image to the annotation display position on an actually taken image corresponding to the viewpoint position.

Moreover, the present invention is characterized by an information processing method, used in an image reproduction apparatus for achieving walk-through in a virtual space represented by using an actually taken image, of synthesizing an annotation image to the actually taken image, the method comprising the steps of: setting an annotation display position in each of the plural actually taken images; calculating an annotation display position to another actually taken image located between the plural actually taken images, by using the annotation display positions respectively set in the plural actually taken images; and synthesizing the annotation image to the actually taken image on the basis of the calculated annotation display position.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the functional structure of a walk-through system according to the embodiment of the present invention;

FIG. 2 is a block diagram showing the hardware structure of an image reproduction apparatus 1 according to the embodiment of the present invention;

FIG. 3 is a diagram for explaining a representation method of a virtual space according to the embodiment of the present invention;

FIG. 4 is a diagram showing an example of attributes of section points and routes;

FIG. 5 is a diagram for explaining correspondence between a panoramic image and a direction of the route;

FIG. 6 is a diagram for explaining an annotation display position determination method in an annotation display position determination unit 50;

FIG. 7 is a flow chart for explaining an operation of the annotation display position determination unit 50;

FIG. 8 is a diagram for explaining an annotation synthesis process by an image reproduction control unit 40;

FIG. 9 is a diagram for explaining a method of determining an object position based on two panoramic images;

FIG. 10 is a flow chart for explaining a procedure to determine the position of each object on a map based on the two panoramic images;

FIG. 11 is a diagram showing a GUI (graphical user interface) 1000 for determining the object position;

FIG. 12 is a diagram for explaining a method of determining the object position on the GUI 1000;

FIG. 13 is a diagram showing a map on which an object to which an annotation is intended to be displayed, section points, and routes are disposed;

FIG. 14 is a diagram showing an example of attributes of the object to which the annotation is displayed;

FIG. 15 is a diagram showing a GUI 2000 for setting an annotation display position in units of panoramic image;

FIG. 16 is a diagram for explaining a method of determining the annotation display position in units of panoramic image on the GUI 2000;

FIG. 17 is a diagram showing attributes of an object to which an annotation is intended to be displayed, according to the third embodiment;

FIG. 18 is a flow chart for explaining a procedure to determine an annotation display position in units of panoramic image, according to the third embodiment;

FIG. 19 is a flow chart for explaining the procedure to determine the annotation display position in units of panoramic image, according to the third embodiment;

FIG. 20 is a flow chart for explaining a procedure to determine an annotation display position for a certain object, in the annotation display position determination unit 50;

FIG. 21 is a diagram for explaining a method of determining an annotation display position according to the fourth embodiment;

FIGS. 22A, 22B and 22C are diagrams for explaining relations of object observation directions θ1 and θ2 from respective panoramic images at two points, and an object observation direction θi from the panoramic image on a route located between the two points; and

FIGS. 23A, 23B, 23C, 23D, 23E, 23F and 23G are diagrams for explaining respective relations of frame numbers and annotation display positions, based on the object observation directions θ1 and θ2.

### DETAILED DESCRIPTION OF THE PREFERRED EMBODIMENTS

Hereinafter, the preferred embodiments of the present invention will be explained with reference to the attached drawings.

(First Embodiment)

Initially, a walk-through system in a virtual space according to the first embodiment of the present invention will be explained. In the present embodiment, panoramic image data is generated from actually taken image data obtained by plural cameras (or shooting devices) mounted on a vehicle such as an automobile or the like, the generated panoramic image data is correlated with positions on a map corresponding to respective positions in a real space, and the correlated data are together stored. Then, a display image is generated based on the stored panoramic image data in accordance with a viewpoint position (i.e., the position on the map) and a sight line direction of an experiencing person (or an observer), thereby achieving walk-through in the virtual space.

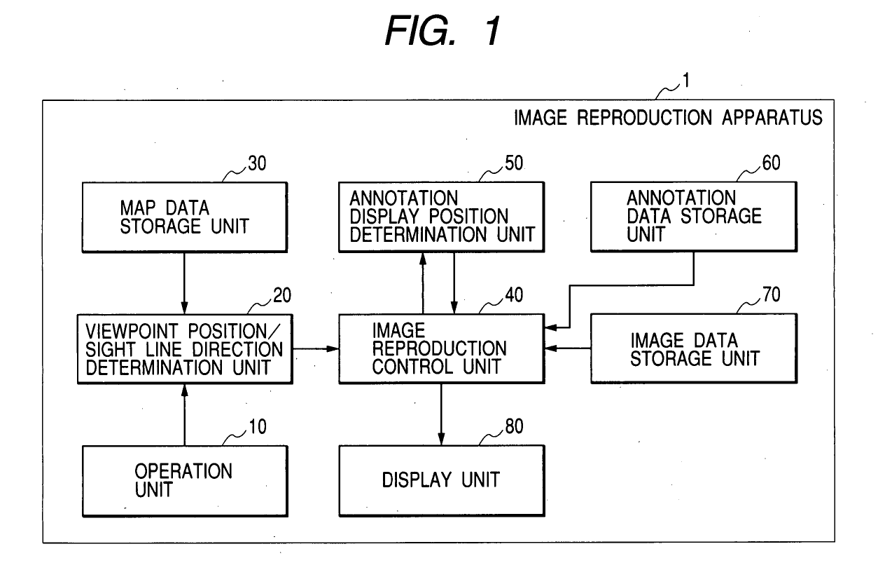

FIG. 1 is a block diagram showing the functional structure of the walk-through system according to the present embodiment. An image reproduction apparatus 1 which constitutes the walk-through system is equipped with an operation unit 10, a viewpoint position/sight line direction determination unit 20, a map data storage unit 30, an image reproduction control unit 40, an annotation display position determination unit 50, an annotation data storage unit 60, an image data storage unit 70, and a display unit 80.

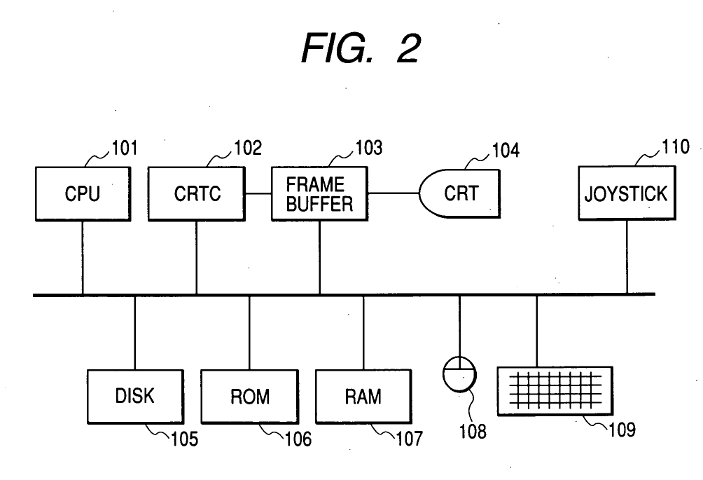

FIG. 2 is a block diagram showing the hardware structure of the image reproduction apparatus 1 according to the present embodiment. Here, it should be noted that the hardware structure shown in FIG. 2 is equivalent to that of an ordinary personal computer. In FIG. 2, a disk 105 acts as the image data storage unit 70, and also acts as the map data storage unit 30 and the annotation data storage unit 60.

A CPU 101 functions as the viewpoint position/sight line direction determination unit 20, the image reproduction control unit 40 and the annotation display position determination unit 50 by executing programs stored in the disk 105, a ROM 106 and/or an external memory (not shown).

Moreover, the CPU 101 issues various display instructions to a CRTC (cathode ray tube controller) 102, whereby desired display is achieved on a CRT 104 by the CRTC 102 and a frame buffer 103. Here, although the CRTC 102 and the CRT 104 are shown respectively as a display controller and a display in FIG. 2, the present invention is not limited to this. That is, instead of the CRT, an LCD (liquid crystal display) or the like can be of course used as the display. Incidentally, the CRTC 102, the frame buffer 103 and the CRT 104 together act as the display unit 80. Besides, a RAM 107 is provided as a working memory for the CPU 101 and the like.

A mouse 108, a keyboard 109 and a joystick 110 which are used by a user to input various data and information to the image reproduction apparatus 1 together act as the operation unit 10.

Next, a schematic operation of the image reproduction apparatus 1 in the walk-through system according to the present embodiment will be explained.

The operation unit 10 which is equipped with the mouse, the keyboard, the joystick and the like is used to generate a movement parameter of the viewpoint position and a rotation parameter of the sight light direction. In the present embodiment, although the joystick 110 is used to control the viewpoint position and the sight line direction, another input device such as a game controller or the like may be used. Incidentally, the inclination angle and the rotation angle of the joystick 110 can be controlled independently. In the present embodiment, the operation to incline the joystick 110 corresponds to the movement of the viewpoint position in the virtual space, and the operation to rotate the joystick 110 rightward and leftward corresponds to the rotation of the sight line direction.

Incidentally, the map data storage unit 30 stores therein two-dimensional map image data.

Moreover, the viewpoint position/sight line direction determination unit 20 determines the viewpoint position and the sight line direction of the observer on the map image represented by the two-dimensional map image data stored in the map data storage unit 30, on the basis of the movement parameter and the rotation parameter input through the operation unit 10.

Furthermore, the image data storage unit 70 stores therein the panoramic image data corresponding to each position on the map. Here, it should be noted that the image data storage unit 70 need not exist as a local device of the image reproduction apparatus 1. That is, it is possible to provide the image data storage unit 70 on a network, and thus read the image data from the image data storage unit 70 through the network.

The image reproduction control unit 40 receives the data concerning the viewpoint position and the sight line direction of the observer on the map from the viewpoint position/sight line direction determination unit 20, and then reads the image data corresponding to the view point position from the image data storage unit 70 based on the received data. Incidentally, in the present embodiment, to correlate the viewpoint position on the map with the image data, the necessary data have the following data storage formats.

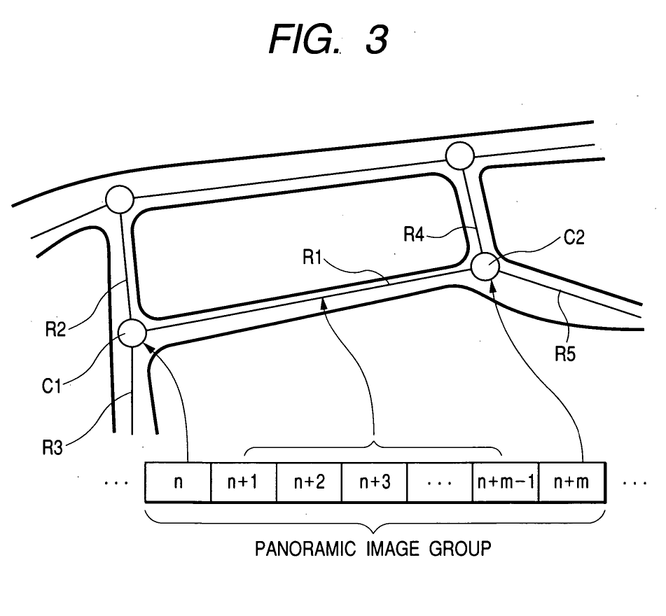

That is, it is assumed that the movement of the observer is limited only on a taking (shooting) route, the route is partitioned by section points such as an intersecting point (diverging point), a corner and the like, and the route is represented as the section points and the route located between the two section points. The section points are set on the two-dimensional image, and the route is the line segment located between the section points. Then, an ID (identification) is added to each of the section points and the routes, the panoramic image taken at the position in the real space is assigned to the corresponding section point, and the panoramic image group between the panoramic images respectively assigned to the section points of both the ends of the route is assigned to the route in question. FIG. 3 shows such an aspect. That is, in FIG. 3, the ID of R1 is given to the line segment (route) located between the section point of which the ID is C1 and the section point of which the ID is C2. Then, in a case where the panoramic images respectively corresponding to the section points C1 and C2 are specified based on GPS (Global Positioning System) data or the like, the panoramic image of which the frame number is n is assigned to the section point C1, and the panoramic image of which the frame number is (n+m) is assigned to the section point C2. After the panoramic images were assigned to the respective section points, the panoramic image group including the panoramic images of which the frame numbers are (n+1) to (n+m−1) is automatically assigned to the route R1. Similarly, the respective panoramic image groups are assigned to the routes R2 to R5 respectively.

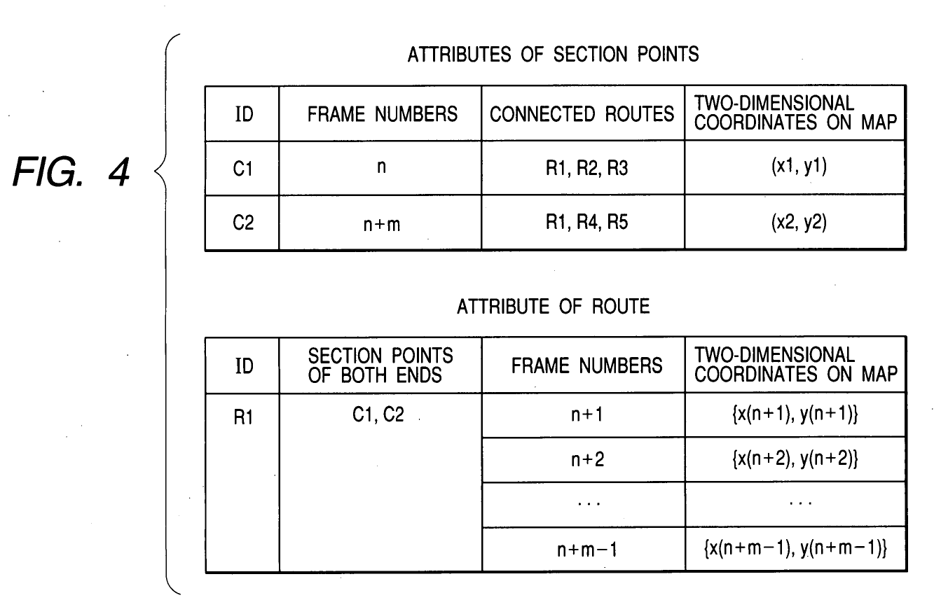

Incidentally, as shown in FIG. 4, each of the section points and the panoramic images has the two-dimensional coordinates on the map as its attribute. Here, although the two-dimensional coordinates on the map are generally calculated from the latitude and longitude data obtained based on the GPS data, the two-dimensional coordinates may be obtained from image information through a computer vision. Moreover, it is possible to obtain the two-dimensional coordinates of only the section points at both the ends of the route based on the latitude and longitude data, and it is further obtain the two-dimensional coordinates of the panoramic images on the route between these section points through an interpolation operation.

The image reproduction control unit 40 gives the viewpoint position on the map to the annotation display position determination unit 50. Then, the annotation display position determination unit 50 determines the display position of the annotation based on the given viewpoint position information, and gives the determined annotation display position to the image reproduction control unit 40. How to determine the annotation-display position will be described later. After then, the image reproduction control unit 40 cuts out the panoramic image according to the angle of view displayed on the display unit 80, performs projection conversion to the cut-out panoramic image, synthesizes the annotation image to the converted panoramic image in accordance with the annotation display position, and then generates the image to be displayed on the display unit 80.

Subsequently, the display unit 80 displays the image generated by the image reproduction control unit 40.

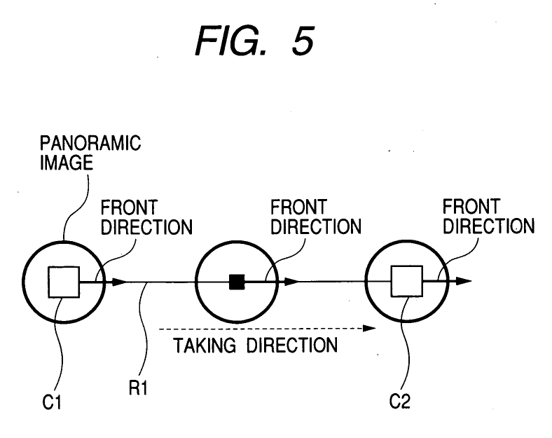

Next, the operation of the annotation display position determination unit 50 will be explained in detail. In the present embodiment, on the route located between the section points as shown in FIG. 5, it is assumed that the front direction of the panoramic image is in parallel with the direction of the route in question, i.e., the camera forwarding direction in the image taking or shooting.

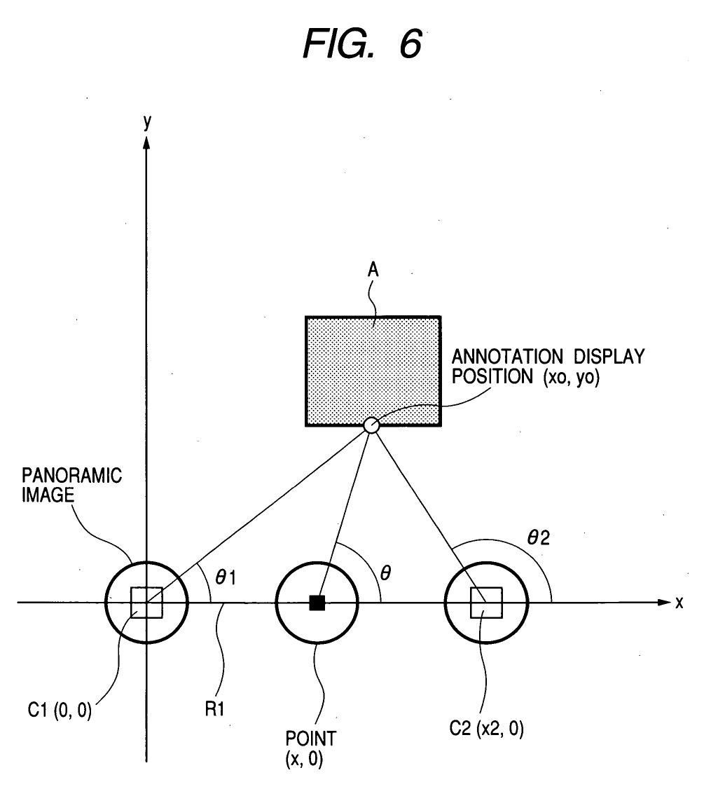

FIG. 6 is a diagram for explaining an annotation display position determination method to be performed by the annotation display position determination unit 50. For simplicity, it is assumed that the section point C1 is the origin of an xy plane, and the section point C2 is set on the x axis of this plane (that is, the route R1 constitutes a part of the x axis).

In FIG. 6, the coordinates of the section point C1, the section point C2 and a building (object) A to which the respective annotations are intended to be displayed on the map are respectively (0, 0), (x2, 0) and (xo, yo). Moreover, in the panoramic image corresponding to the section point C1, the horizontal position (i.e., position in horizontal direction) at which the annotation of the building A is displayed is represented in a relative angle θ1 (radian) from the front direction of the panoramic image, as follows.

$$θ1 = \{ \begin{matrix}arctan ( yo / xo ) ( xo \neq 0 ) \\ Π / 2 ( xo = 0 , yo > 0 ) \\ - Π / 2 ( xo = 0 , yo < 0 )\end{matrix}$$

Furthermore, in the panoramic image corresponding to the section point C2, the horizontal position at which the annotation of the building A is displayed is represented in a relative angle θ2 (radian) from the front direction of the panoramic image, as follows.

$$θ2 = \{ \begin{matrix}arctan \{ yo / xo - x2 ) \} ( xo \neq x2 ) \\ Π / 2 ( xo = x2 , yo > 0 ) \\ - Π / 2 ( xo = x2 , yo < 0 )\end{matrix}$$

Similarly, in the panoramic image corresponding to the point (x, 0) on the route R1, the horizontal position at which the annotation of the building A is displayed is represented in a relative angle θ (radian) from the front direction of the panoramic image, as follows.

$$θ = \{ \begin{matrix}arctan \{ yo / xo - x ) \} ( xo \neq x ) \\ Π / 2 ( xo = x , yo > 0 ) \\ - Π / 2 ( xo = x , yo < 0 )\end{matrix}$$

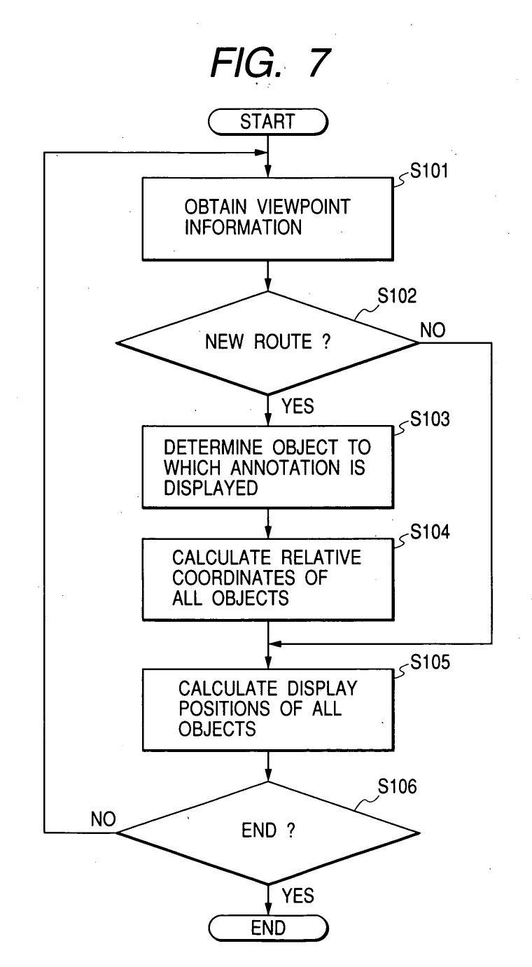

The annotation display position determination unit 50 determines the horizontal positions at which the annotations are displayed, in accordance with the above formulae. FIG. 7 is a flow chart for explaining the operation of the annotation display position determination unit 50. In FIG. 7, in a step S101, new viewpoint information (i.e., the viewpoint position and the sight line direction) is first obtained. Then, it is judged in a step S102 whether or not the route determined based on the new viewpoint information obtained in the step S101 is the same as the route in the previous frame. When it is judged that the route determined based on the new viewpoint information is the same as the route in the previous frame, the flow advances to a step S105. On the contrary, when it is judged in the step S102 that the route determined based on the new viewpoint information is a new route different from the route in the previous frame, the flow advances to a step S103. In the step S103, the object to which the annotation is displayed is determined on the route in question. In the present embodiment, it should be noted that the annotations can be respectively displayed to the plural objects. After the object to which the annotation is displayed was determined in the step S103, the flow advances to a step S104. In the step S104, one of the section points at both the ends of the route in question is set as the origin of the xy plane, the coordinate axis is rotated so that the route in question coincides with the x axis, and the relative positions of all the objects to which the annotations are respectively displayed are calculated. Next, in the step S105, an annotation display position θ (i.e., a relative angle from the front direction of the panoramic image) in the panoramic image corresponding to the viewpoint position in question is obtained by the above formula, in regard to each of all the objects to which the annotations are respectively displayed. After then, it is judged in a step S106 whether or not to end the operation. When the operation should be continued, the flow returns to the step S101 to again obtain new viewpoint information.

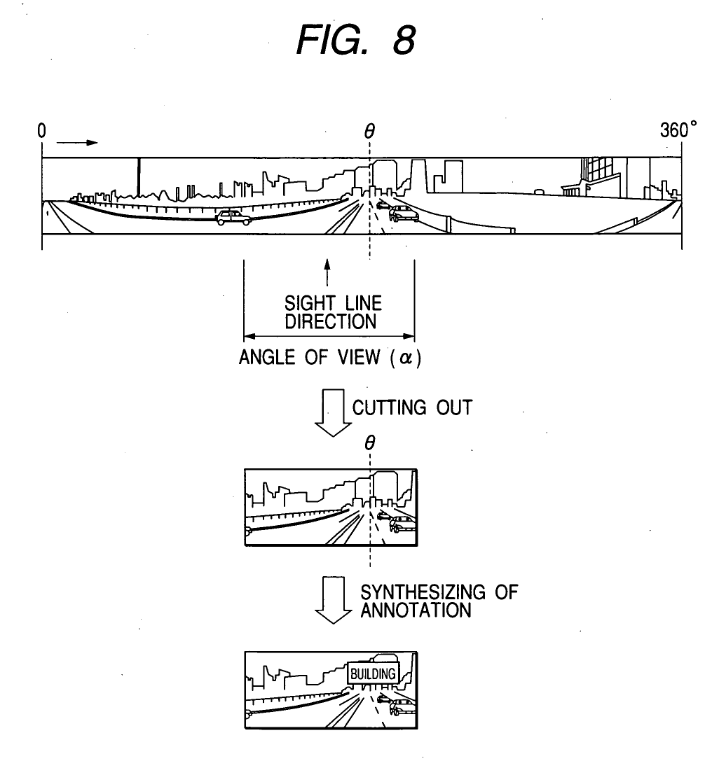

FIG. 8 is a diagram for explaining an annotation synthesis process by the image reproduction control unit 40. When the annotation display position θ is determined by the annotation display position determination unit 50, the image reproduction control unit 40 cuts out the panoramic image according to the sight line direction and an angle of view a. Then, the annotation image read from the annotation data storage unit 60 is synthesized on the cut-out panoramic image, whereby the display image is finally generated. Here, it should be noted that clinographic conversion for converting the panoramic image into a perspective projection image is performed only to the panoramic image.

As described above, according to the first embodiment, the annotation display position is determined based on the coordinates of the object position to which the annotation is intended to be displayed and the viewpoint position of the observer on the two-dimensional map, whereby it is possible to achieve saving of work and time when the annotation display positions are determined to a large number of images.

(Second Embodiment)

In the above first embodiment, the annotation display position is determined based on the coordinates, on the map, of the object position to which the annotation is intended to be displayed and the viewpoint position of the observer. On one hand, in the second embodiment, the position of an object on the map is determined based on the observation directions of that object in two panoramic images, whereby an annotation can be displayed at an appropriate position even if accuracy of the coordinates of the object position and the sight line direction on the map is low.

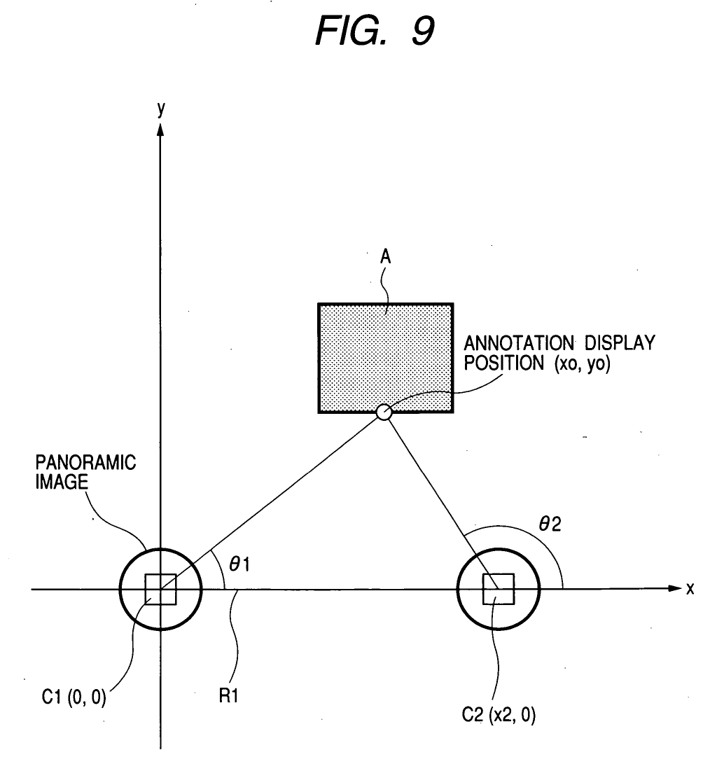

FIG. 9 is a diagram for explaining a method of determining the object position based on the two panoramic images. In the present embodiment, the position of the object on the map is determined based on the coordinates of the viewpoint position on the map, and moreover the position of the object on the map is determined in regard to each route. Incidentally, when the annotation display position is calculated, the position of the object on the map determined on the route where the viewpoint position exists is used. In FIG. 9, for simplicity, it is assumed that a section point C1 is the origin of the xy plane, and a section point C2 is set on the x axis of this plane (that is, a route R1 constitutes a part of the x axis). Moreover, the coordinates of the section points C1 and C2 are (0, 0) and (x2, 0) respectively, and the front direction of the panoramic image on the route R1 always corresponds to the positive direction of the x axis.

When the observation direction (i.e., the relative direction from the front direction) from the section point C1 of an object (a building) A to which the annotation is intended to be displayed is 01 and the observation direction from the section point C2 is 02, the coordinates (xo, yo) of the object on the map can be obtained from following formulae.

$$\begin{matrix}x0 = \{ \begin{matrix}0 & ( θ1 = Π / 2 , - Π / 2 ) \\ x2 & ( θ2 = Π / 2 , - Π / 2 ) \\ x2 tan θ 2 / ( tan θ2 - tan θ 1 ) & ( other )\end{matrix} \\ y0 = \{ \begin{matrix}- x2 tan θ2 & ( θ1 = Π / 2 , - Π / 2 ) \\ x2 tan θ1 & ( θ2 = Π / 2 , - Π / 2 ) \\ x2 tan θ 1 tan θ2 / ( tan θ2 - tan θ 1 ) & ( other )\end{matrix}\end{matrix}$$

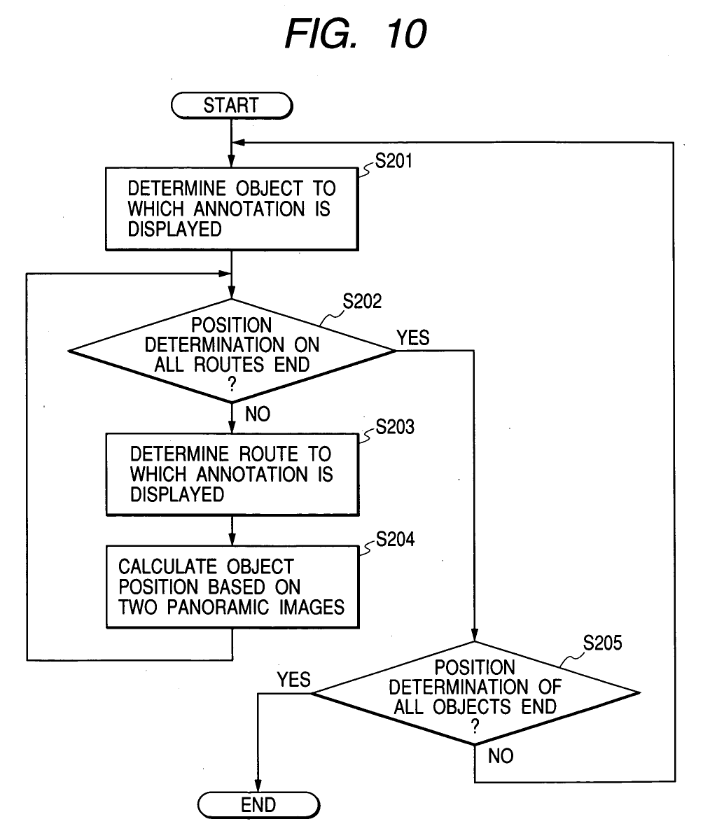

FIG. 10 is a flow chart for explaining a procedure to determine the position of the object on the map based on the two panoramic images. Initially, in a step S201, the object to which the annotation is intended to be displayed is determined. Next, it is judged in a step S202 whether or not the object position determination ends on all the routes to which the annotation of the object in question is displayed. When it is judged that the object position determination does not end on all the routes, the flow advances to a step S203 to determine the route to which the object position determination should be performed. Then, in a step S204, the object position on that route is calculated by the above formulae. On the contrary, when it is judged in the step S202 that the object position determination ends on all the routes, the flow advances to a step S205. Then, it is judged in the step S205 whether or not the position determination ends to all the objects to which the annotations are intended to be displayed. When it is judged that the position determination ends to all the objects, the position determination ends. On the contrary, when it is judged that the position determination does not end to all the objects, the flow returns to the step S201 to determine the next object.

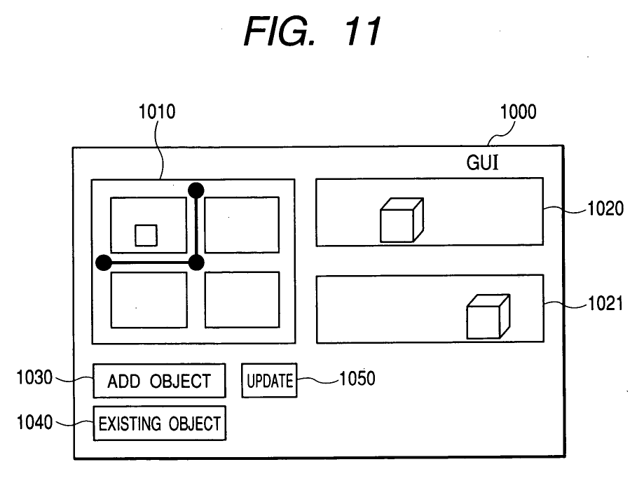

FIG. 11 is a diagram showing a GUI 1000 for determining the object position in the present embodiment. The GUI 1000 includes a map display window 1010 for displaying a two-dimensional map image, panoramic image display windows 1020 and 1021 for displaying panoramic images corresponding to the section points at both the ends of the route selected on the map display window 1010, an object addition button 1030, an existing object button 1040, and an update button 1050.

When the position determination is performed to a new object to which any position determination is not yet performed, the object addition button 1030 is clicked by a mouse. On one hand, when the position of the object to which the position determination has been performed is corrected, the existing object button 1040 is clicked by the mouse to select the desired object from the list of the objects to be displayed.

The map display window 1010 displays the two-dimensional map image on which the section points and the routes are displayed. When the user clicks by the mouse the route to which the object position is intended to be determined, the panoramic images respectively corresponding to the section points at both the ends of the selected route are displayed respectively on the panoramic image display windows 1020 and 1021.

Incidentally, it should be noted that the two typical panoramic images may not be the panoramic images respectively corresponding to the section points at both the ends of the route. That is, the two typical panoramic images may be panoramic images at independent positions respectively designated on the map by the user. For example, panoramic images at the positions of the section points on the different routes may be used.

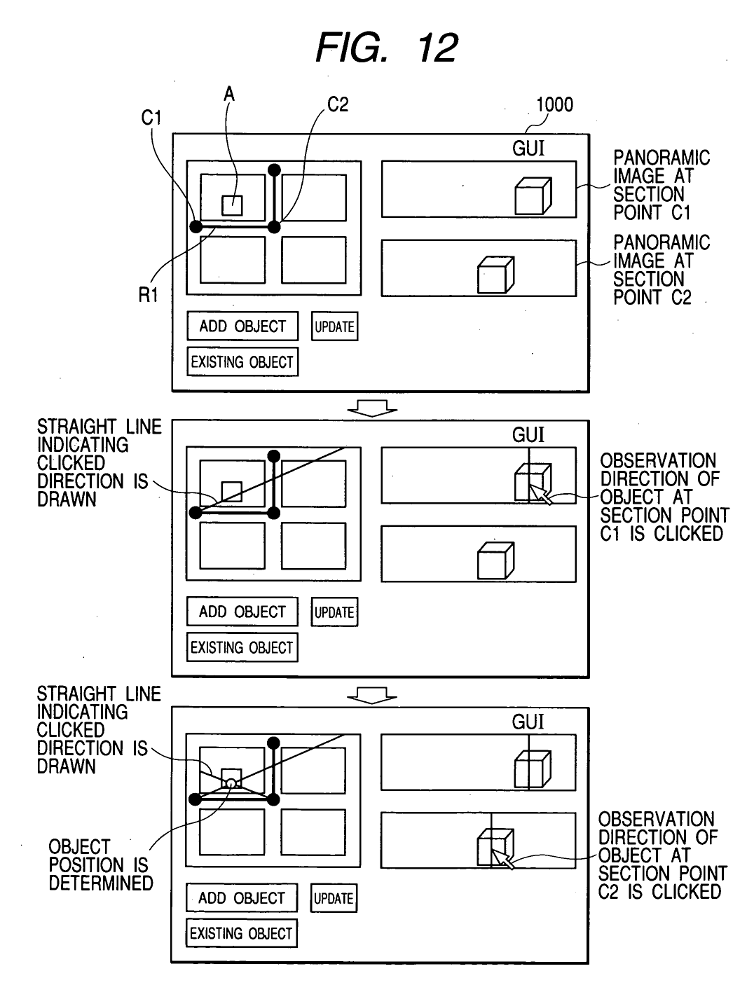

FIG. 12 is a diagram for explaining a method of determining the object position on the GUI 1000. Here, a case where the position of the object (building) A on the route R1 located between the section points C1 and C2 is determined will be explained. When the route R1 is clicked by the mouse, the panoramic images corresponding to the respective section points C1 and C2 are displayed on the panoramic image display windows 1020 and 1021 respectively. First, on the panoramic image display window 1020, when the direction in which the object A is observed is clicked by the mouse, the straight line parallel with the vertical direction of the panoramic image passing the clicked point on the panoramic image display window 1020 is drawn, and the straight line indicting the clicked direction is drawn on the map display window 1010. Then, the similar operations are performed on the panoramic image display window 1021 and the map display window 1010. As a result, on the map display window 1010, the point at which the two straight lines intersect is calculated and obtained as the position of the object A on the route R1.

When the object position determination is performed on all the routes to which the annotations are intended to be displayed, the update button 1050 is depressed to store the obtained position data.

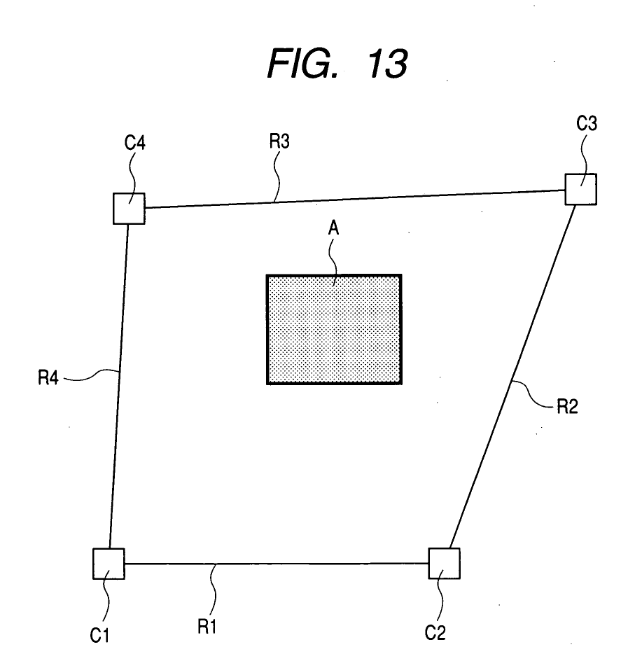

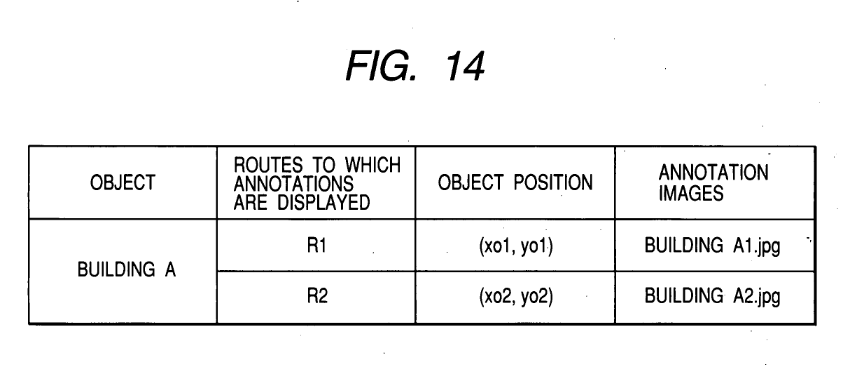

FIG. 13 is a diagram showing a map on which an object to which an annotation is intended to be displayed, section points, and routes are disposed. In FIG. 13, the object (building) A can be observed from routes R1, R2, R3 and R4. Thus, when the annotation of the object A is displayed on the routes R1 and R2, the position of the object A on the route R1 is calculated from the panoramic images corresponding to the section points C1 and C2, and the position of the object A on the route R2 is calculated from the panoramic images corresponding to the section points C2 and C3. FIG. 14 is a diagram showing an example of attributes of the object to which the annotation is displayed. That is, the position coordinates (xo1, yo1) of the object on the map are used when the annotation display position on the route R1 is determined, and the position coordinates (xo2, yo2) of the object on the map are used when the annotation display position on the route R2 is determined. Here, it should be noted that the annotation image can be made different in regard to each route.

Incidentally, the annotation image is given as an image according to a JPEG (Joint Photographic Experts Group) format in FIG. 14. However, another image format may be of course used, and besides, a moving image may be used as the annotation image.

Then, the annotation display position determination unit 50 determines the position at which the annotation is displayed, by using the position coordinates of the object determined as above on the map.

As described above, according to the second embodiment, because the position of the object on the map is determined based on the observation directions of the object in question in the two panoramic images, the annotation can be displayed at the appropriate position even if accuracy of the coordinates of the object position and the sight line direction on the map is low.

Moreover, because the GUI is used, the position of the object on the map can be easily determined.

(Third Embodiment)

In the above second embodiment, the position of the object to which the annotation is intended to be displayed on the map is determined based on the observation directions of the object in question in the two panoramic images. On one hand, in the third embodiment, it enables to set an annotation display position in units of panoramic image and preferentially use the set annotation display position, thereby performing annotation display at a more appropriate position.

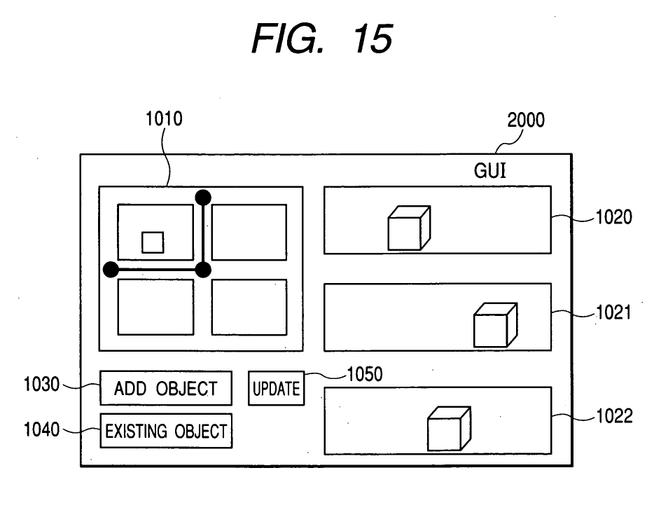

FIG. 15 is a diagram showing a GUI 2000 for setting the annotation display position in units of panoramic image. In FIG. 15, because a map display window 1010, panoramic image display windows 1020 and 1021, an object addition button 1030, an existing object button 1040 and an update button 1050 are respectively the same as those shown in FIG. 11, the explanations thereof will be omitted. Besides, a panoramic image display window 1022 is used to display the panoramic image corresponding to an arbitrary point on the selected route.

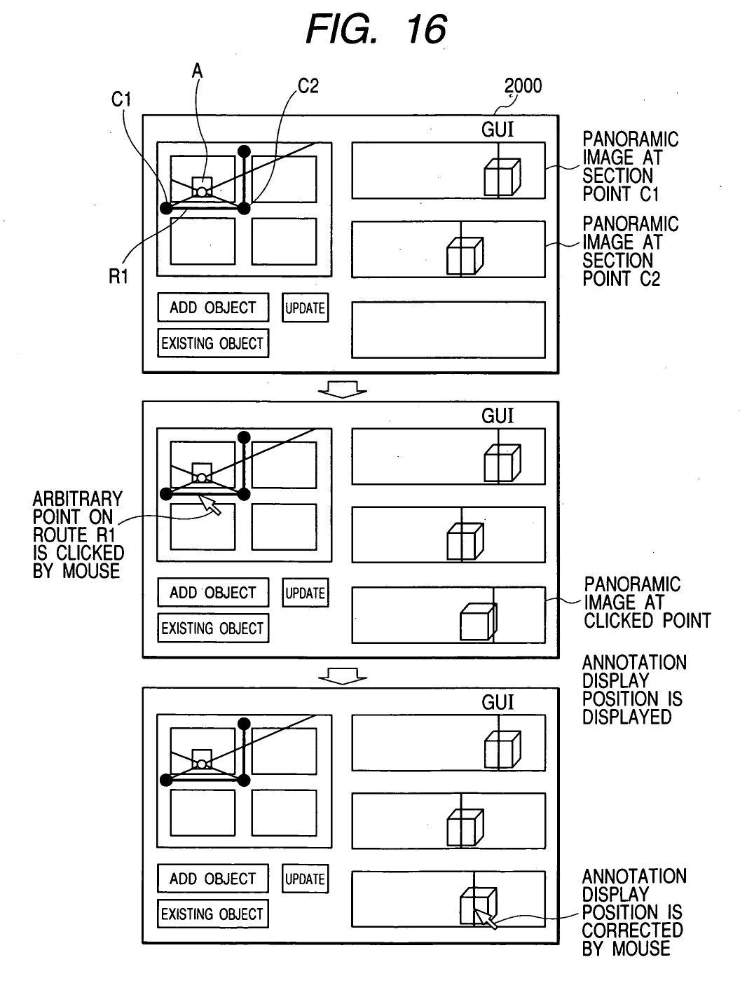

FIG. 16 is a diagram for explaining a method of determining the annotation display position in units of panoramic image on the GUI 2000. Here, after the position of the object (building) A was determined from the observation directions of the panoramic images at the two section points, when a point on the route is clicked by the mouse, the panoramic image corresponding to the clicked point is displayed on the panoramic image display window 1022. At the same time, the annotation display position determined from the position of the object A is represented as the straight line parallel with the vertical direction of the panoramic image. When accuracy of the position coordinates of the panoramic image on the map is low, there is a fear that the represented annotation display position is deviated or shifted from the position at which the annotation is intended to be actually displayed. Therefore, the appropriate annotation display position is clicked on the panoramic image display window 1022 to prevent this. As described above, the annotation display position determined in units of panoramic image is used in preference to the annotation display position determined from the position of the object on the map and the viewpoint position in the annotation display position determination unit 50.

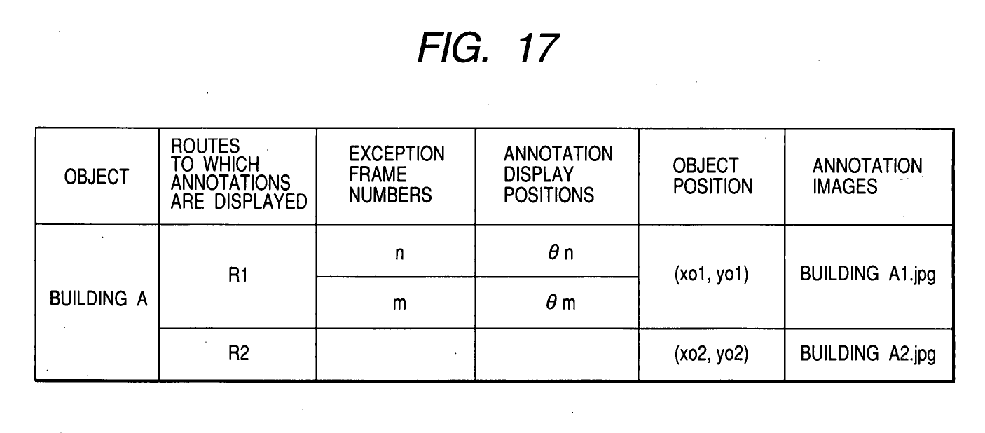

FIG. 17 is a diagram showing attributes of the object to which the annotation is intended to be displayed, according to the third embodiment. That is, in regard to the object (the building A), the annotation display positions are set independently for the two panoramic images (frame numbers n and m) on the route R1. The independently set annotation display positions are described as relative angles On and θm from the front direction of the panoramic image.

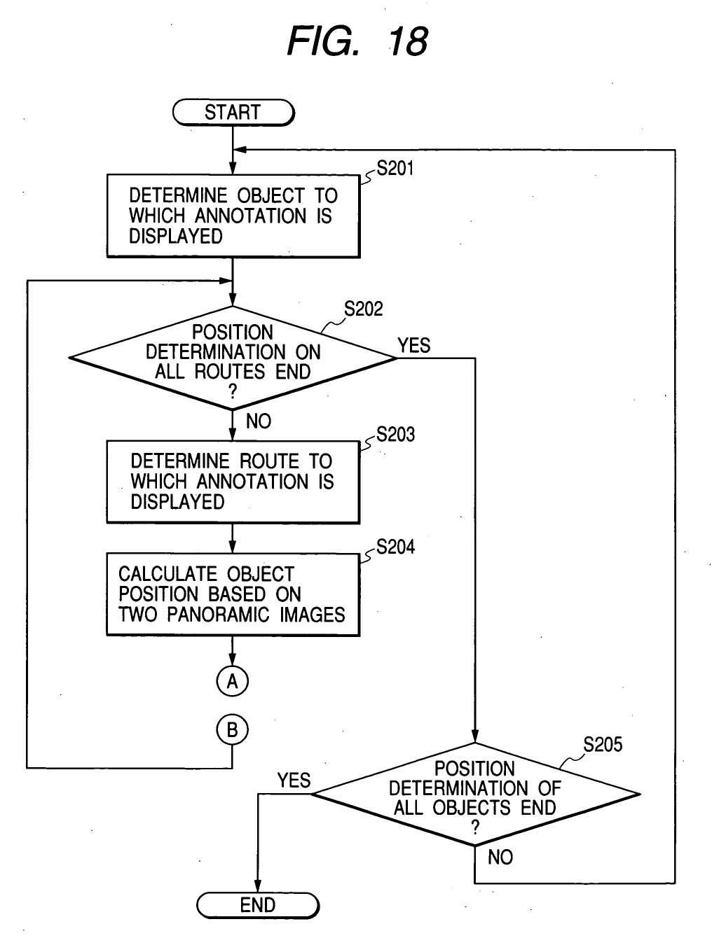

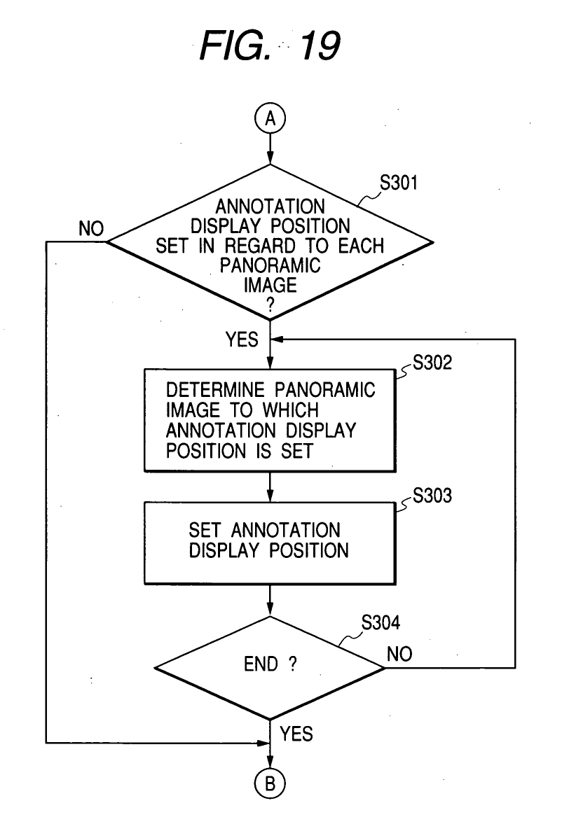

FIG. 18 is a flow chart for explaining a procedure to determine the annotation display position in units of panoramic image, according to the third embodiment. In FIG. 18, because the processes in steps S201 to S205 are respectively the same as those shown in FIG. 10, the explanations thereof will be omitted. Then, in FIG. 19, when it is judged in a step S301 not to determine the annotation display position in units of panoramic image, the flow returns to the step S202 (FIG. 18). On the contrary, when it is judged to determine the annotation display position in units of panoramic image, the flow advances to a step S302 to select and determine the panoramic image to which the annotation display position is determined. Next, in a step S303, the annotation display position is set in the panoramic image in question. After then, it is judged in a step S304 whether or not to end the operation. When the annotation display position is determined to another panoramic image, the flow returns to the step S302.

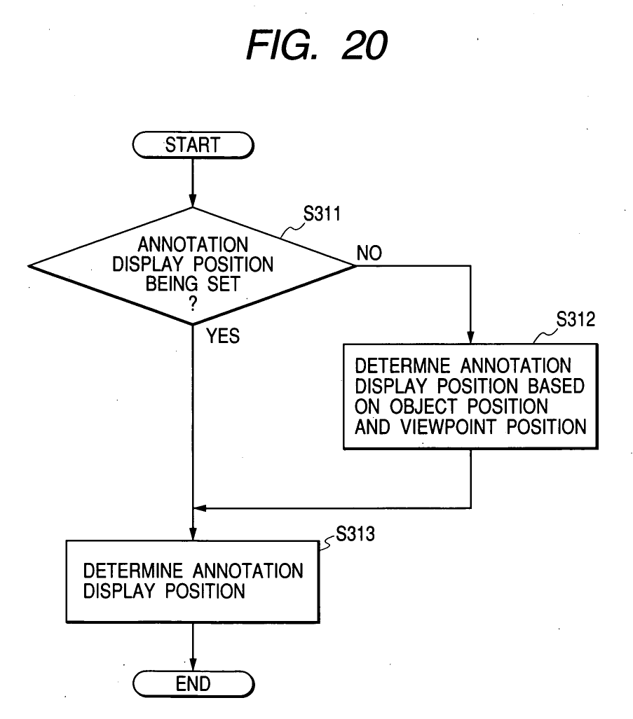

FIG. 20 is a flow chart for explaining a procedure to determine the annotation display position for a certain object, in the annotation display position determination unit 50. First, when it is judged in a step S311 that the annotation display position for the certain object has been set in the panoramic image corresponding to the viewpoint position, the set annotation display position is used as it is. On the contrary, when it is judged that the annotation display position for the certain object is not set, the annotation display position is determined from the object position and the viewpoint position in a step S312, and then the determined annotation display position is used. After then, the annotation display position is determined in a step S313, and the operation ends.

As described above, according to the third embodiment, the annotation display position can be set in units of panoramic image, and the set annotation display position can be preferably used, whereby the annotation display can be performed at the more appropriate position.

Moreover, the GUI is used, whereby the annotation display position can be easily set in units of panoramic image.

(Fourth Embodiment)

In the above first to third embodiments, the annotation display position is determined based on the observer's viewpoint position on the map and the object position on the map. On one hand, in the fourth embodiment, the annotation display position is easily determined without using a position on the map.

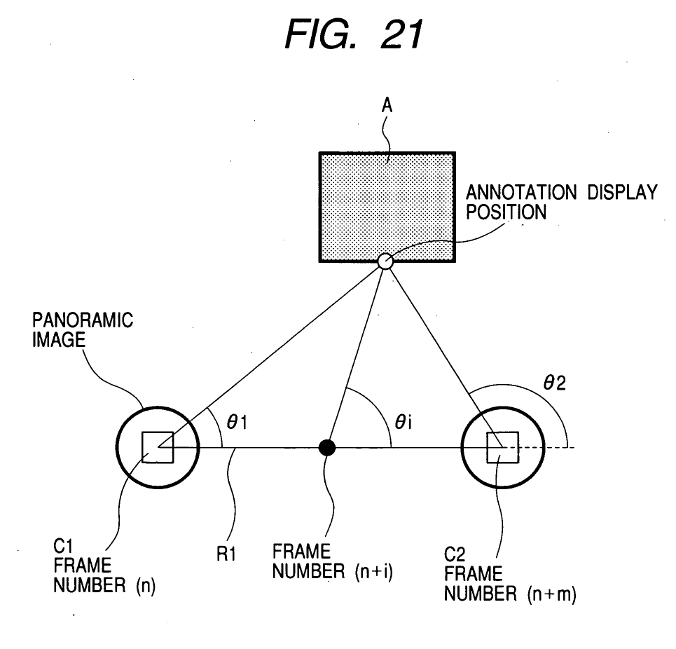

FIG. 21 is a diagram for explaining a method of determining the annotation display position according to the fourth embodiment. In FIG. 21, it is assumed that a route R1 beginning from a section point C1 and ending to a second point C2 is represented by the straight line. Moreover, it is assumed that the front direction of a panoramic image corresponding to the section point C1, the front direction of a panoramic image corresponding to the section point C2, and the front directions of panoramic images included in a group corresponding to the route R1 are all the same (i.e., the direction extending from the section point C1 to the section point C2). Furthermore, it is assumed that the panoramic image of which the frame number is n is related to the section point C1, the panoramic image of which the frame number is (n+m) (m>0) is related to the section point C2, and the panoramic images of which the frame numbers are (n+1) to (n+m−1) are related to the route R1.

When the annotation of a building (object) A shown in FIG. 21 is displayed to the group of the panoramic images related to the route R1, observation angles θ1 and θ2 of the building A at the section points C1 and C2 of both the ends of the route R1 are first obtained. Here, the observation angles θ1 and θ2 are obtained beforehand in a preprocess in regard to each route.

In the annotation display position determination unit 50, when the observation directions of the building A from the section points C1 and C2 are respectively given by the observation angles θ1 and θ2, an annotation display position (angle) θi of the building A in the panoramic image of a frame number (n+i) (i>0) on the route R1 is obtained by linear interpolation, as follows.

θi=(θ2−θ1)/m×i+θi

As described above, according to the fourth embodiment, the linear interpolation is performed to the object observation directions of the panoramic images at the two points, whereby the annotation display position can be easily determined to the group of the panoramic images related to the route located between the two points. Moreover, the linear interpolation is used to obtain the annotation display position, whereby an amount of the calculation can be reduced.

(Fifth Embodiment)

In the above fourth embodiment, the annotation display position is obtained by performing the linear interpolation to the object observation directions of the panoramic images at the two points. On one hand, according to the fifth embodiment, the annotation display position is obtained more precisely by performing non-linear interpolation.

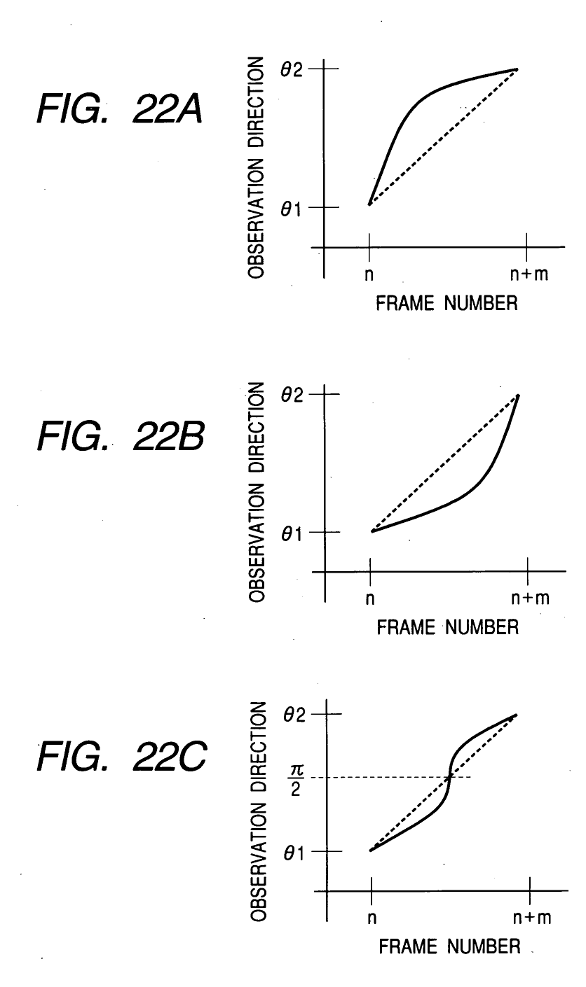

FIGS. 22A, 22B and 22C are diagrams for explaining the relations of the object observation directions (angles) θ1, θ2 and θi shown in FIG. 21. In each of FIGS. 22A, 22B and 22C, the horizontal axis indicates frame numbers, and the vertical axis indicates object observation directions. Moreover, the range of the object observation direction θ1 is limited to 0≦θ1≦n, and the range of the object observation direction θ2 is limited to 0≦θ2≦n. Furthermore, it is assumed that the intervals of the frame taking positions on the route R1 are all equal. Here, FIG. 22A shows the object observation directions from the respective frames on the route R1 in case of n/2≦θ2≦n and n/2≦θ2≦n. FIG. 22B shows the object observation directions from the respective frames on the route R1 in case of 0≦θ1≦n/2 and n/2≦θ2≦n. FIG. 22C shows the object observation directions from the respective frames on the route R1 in case of 0≦θ1≦n/2 and 0≦θ2≦n/2. As shown in FIGS. 22A to 22C, when it is assumed that the panoramic images are taken at the same intervals, the object observation directions do not change linearly but change non-linearly. Incidentally, each of the non-linear curves shown in FIGS. 22A to 22C corresponds to an arctangent function obtained by the object observation directions (angles) θ1 and θ2.

When the annotation display position of the object is determined by the annotation display position determination unit 50, the annotation display position (angle) θi is determined by using, as an interpolation function, the arctangent function obtained from the object observation directions (angles) θ1 and θ2 from the two section points at both the ends of the route. Incidentally, to reduce an amount of calculation, a linearly approximated function of the arctangent function may be uses as the interpolation function.

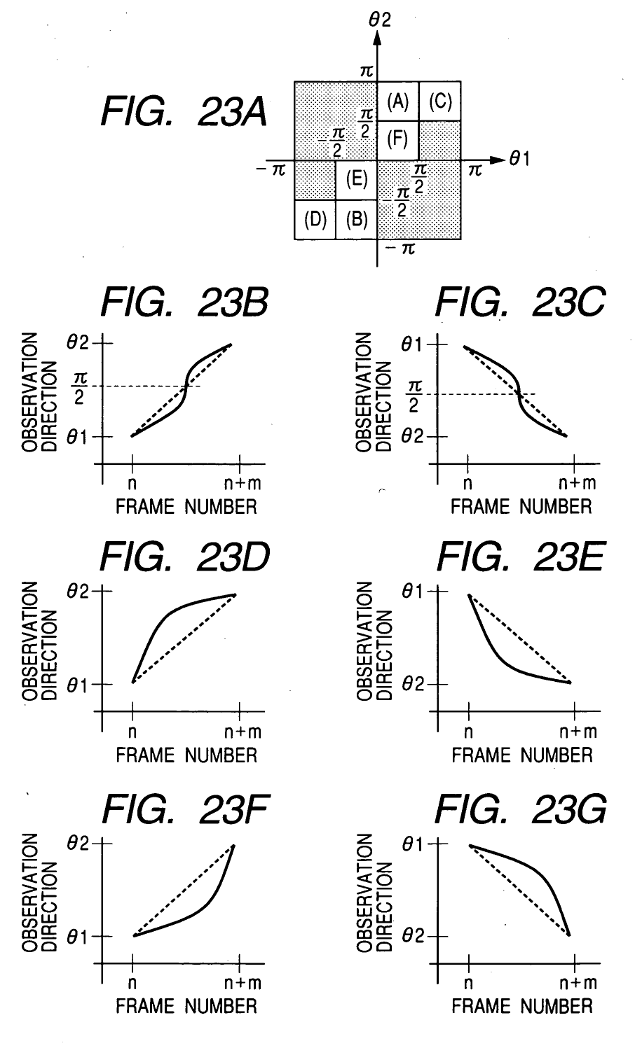

Moreover, to reduce an amount of calculation by the arctangent function, a table which indicates the relations between frame numbers and annotation display positions may be prepared beforehand. As shown in FIGS. 23A, 23B, 23C, 23D, 23E, 23F and 23G, in case of −n<θ1≦n and −n<θ2≦n, the relations between the frame numbers and the annotation display positions are classified into six kinds (or patterns) of arctangent-function shapes in accordance with the object observation directions θ1 and θ2. The annotation display position determination unit 50 holds beforehand the correspondence table which indicates six-pattern relations between the frame numbers and the annotation display positions based on representative values of the object observation directions θ1 and θ2, judges to which of the six patterns the target is closest on the basis of the object observation directions θ1 and θ2 from the section points at both the ends of the current route, and refers to the value of the correspondence table on the basis of the corresponding frame number. It should be noted that it may be judged beforehand to which of the six patterns the target is closest. The correspondence table changes according to the number of panoramic images related to the route. Here, the correspondence table is formed beforehand with sufficiently fine resolutions, and the scale thereof is controlled according to the number of panoramic images on the corresponding route, whereby the number of correspondence tables is controlled. Incidentally, although the six correspondence tables are provided in the present embodiment, the number of correspondence tables can be increased according to the capacity of a RAM or the like. Moreover, in a case where the small number of correspondence tables are provided initially, when approximation cannot be achieved by the current correspondence tables in view of the actual annotation display positions, the interpolation functions determined by using the object observation directions from the section points at the both ends of the route to which the displaying is deviated or shifted are added as needed. By doing so, the accuracy can be increased.

As described above, according to the fifth embodiment, the interpolation is performed by using the arctangent functions obtained based on the object observation directions from the panoramic images at the two points, the annotation display positions can be determined more accurately to the group of the panoramic images related to the route located between the two points.

(Other Embodiments)

Although the panoramic images are used in the above embodiments, images other than the panoramic image may be also used.

Moreover, to provide program codes of software for achieving the functions of the above embodiments through a network is included in the concept of the present invention.

In this case, the program codes themselves of software achieve the functions of the above embodiments, whereby the program codes themselves and a means for supplying the program codes to a computer constitute the present invention.

Moreover, it is to be understood that the present invention includes not only the case where the functions of the above embodiments are achieved when the computer executes the supplied program codes but also a case where the functions of the above embodiments are achieved when the computer executes the supplied program codes in cooperation with an operating system (OS) running on the computer, another application software or the like.

As many apparently widely different embodiments of the present invention can be made without departing from the spirit and scope thereof, it is to be understood that the invention is not limited to the specific embodiments thereof except as defined in the appended claims.

What is claimed is:

1. An information processing method comprising:
a viewpoint position/sight line direction determination step of determining a viewpoint position and a sight line direction on a map;
an annotation display position determination step of determining an annotation display position of an object, from the position of said object on the map determined based on observation directions of said object in plural panoramic images, the viewpoint position, and the sight line direction; and
a synthesis step of synthesizing an annotation image to the annotation display position on an actually taken image corresponding to the viewpoint position.

2. An information processing method according to claim 1, wherein the map is a two-dimensional map image.

3. An information processing method according to claim 1, wherein said annotation display position determination step determines the annotation display position of the panoramic image located between said plural panoramic images, by using the determined position of the object on the map.

4. An information processing method according to claim 3, wherein the determined annotation display position can be manually adjusted.

5. An information processing method according to claim 1, wherein
a graphical user interface including a map display portion and a panoramic image display portion is provided,
said plural panoramic images are selected by using the map display portion, and
the observation direction of the object is designated on the selected panoramic image displayed on the panoramic image display portion.

6. A control program for causing a computer to execute a information processing method comprising:
a viewpoint position/sight line direction determination step of determining a viewpoint position and a sight line direction on a map;
an annotation display position determination step of determining an annotation display position of an object, from the position of said object on the map determined based on observation directions of said object in plural panoramic images, the viewpoint position, and the sight line direction; and
a synthesis step of synthesizing an annotation image to the annotation display position-on an actually taken image corresponding to the viewpoint position.

7. An information processing method, used in an image reproduction apparatus for achieving walk-through in a virtual space represented by using an actually taken image, of synthesizing an annotation image to the actually taken image, said method comprising the steps of:
setting an annotation display position in each of the plural actually taken images;
calculating an annotation display position to another actually taken image located between the plural actually taken images, by using the annotation display positions respectively set in the plural actually taken images; and
synthesizing the annotation image to the actually taken image on the basis of the calculated annotation display position.

8. An information processing method according to claim 7, wherein
the setting of the annotation display position in each of the plural actually taken images is performed according to a user's manual instruction, and the calculated annotation display position can be adjusted based on a user's manual instruction.

9. An information processing method according to claim 7, wherein the annotation display position to said another actually taken image is calculated by performing interpolation to the annotation display position set in each of the plural actually taken images.

10. An information processing method according to claim 9, wherein
the interpolation is non-linear interpolation, and
from among plural non-linear curves previously held, the non-linear curve is determined based on the annotation position of the object in each of the plural actually taken images.

11. A control program for causing a computer to execute a information processing method, used in an image reproduction apparatus for achieving walk-through in a virtual space represented by using an actually taken image, of synthesizing an annotation image to the actually taken image, said method comprising the steps of:
setting an annotation display position in each of the plural actually taken images;
calculating an annotation display position to another actually taken image located between the plural actually taken images, by using the annotation display positions respectively set in the plural actually taken images; and
synthesizing the annotation image to the actually taken image on the basis of the calculated annotation display position.

12. An image reproduction apparatus comprising:
a viewpoint position/sight line direction determination unit, adapted to determine a viewpoint position and a sight line direction on a map;
an annotation display position determination unit, adapted to determine an annotation display position of an object from the position of said object on the map determined based on observation directions of said object in plural panoramic images, the viewpoint position, and the sight line direction; and
an image reproduction control unit, adapted to synthesize an annotation image to the annotation display position on an actually taken image corresponding to the viewpoint position.
